(19) United States
(12) Patent Application Publication
(10) Pub. No.: US 2008/0053903 A1
(43) Pub. Date: Mar. 6, 2008

(54) Process for extracting oil from tar sand and shale

(76) Inventor: Bret A. Bowman, Sandy, UT (US)

Correspondence Address: ALAN J. HOWARTH, P.O. BOX 1909, SANDY, UT, 84091-1909, US

(21) Appl. No.: 11/512,950

(22) Filed: Aug. 29, 2006

(51) Int. Cl. B01D 11/04

(52) U.S. Cl. 210/639; 210/634; 210/776; 210/774; 210/775; 208/179

(57) ABSTRACT

A process for extracting oil substances such as bitumen from materials such as tar sands and shales. The process may include placing the material and water in an enclosed conduit and applying heat to the water and material. The pressure inside the conduit may be increased such that temperatures above the boiling point of water may be achieved. The water and material may then be transported to a second portion of the conduit for cooling such that emissions of volatile substances into the atmosphere may be reduced. The oil substances in the material may be washed out of the material with the water and float to the top of the water where they may be separated from the water and removed from the process for further refinement. The water and remaining material may be withdrawn from the conduit for treatment or recycling.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Invention

The present disclosure relates generally to oil production processes, but not necessarily entirely, to a process for extracting oil substances from materials such as tar sands and shale containing such oil substances.

2. Description of Related Art

Enormous reserves of tar sands and oil shale are available. Tar sands, also referred to as oil sands or bituminous sands, are a combination of clay, sand, water, and bitumen. The bitumen may be neither oil nor tar, but rather a semisolid, degraded form of oil that will not flow toward producing wells under normal conditions, making it difficult and expensive to produce. Tar sands may be mined to extract the oil-like bitumen that may be upgraded into synthetic crude oil or refined directly into petroleum products by specialized refineries. Whereas conventional oil may be extracted by drilling traditional wells into the ground, tar sand deposits are usually mined using strip mining techniques, or persuaded to flow into producing wells by in-situ techniques that reduce the bitumen's viscosity with steam and/or solvents. The in-situ techniques usually require high amounts of energy and effort to be successful.

Oil shale is a general term applied to a group of rocks rich enough in organic material to yield petroleum. The amount of tar sands and oil shale available are sufficient to provide energy to last the world hundreds of years by conservative estimates. Thus, tar sands and oil shale are logical resources for use in achieving energy independence.

Moreover, production of fuels from U.S. oil shale and tar sand assets represents an attractive alternative for decreasing U.S. reliance on imported oil, reducing trade deficits, and providing more economical energy than current markets offer.

One known process for extracting bitumen from tar sand is sometimes referred to as the “hot water process”, in which water is heated and added to the tar sand to liberate and separate bitumen from the tar sand. The tar sand may be agitated and the bitumen may float to the top of the water, while the sand settles to the bottom. The bitumen may then be separated from the water. One disadvantage of the hot water process is that the energy requirement to heat the water may be very high. Also, the temperature of the water applied to the tar sand is limited to the boiling point of water such that advantages and efficiencies of higher temperatures may not be achieved. Moreover, the hot water process often exposes vapors to the environment as the bitumen is separated from the tar sand and the tar sands and water are cooled.

Despite the advantages of the known processes for extracting hydrocarbons, such as oil, from materials such as sand and shale, improvements are still being sought. The prior art is characterized by several disadvantages that are addressed by the present disclosure. The present disclosure minimizes, and in some aspects eliminates, some of the failures, and other problems, of the prior art by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic view of one embodiment of a process for extracting oil substances from materials bearing the oil substances;

FIG. 2 is a schematic view of another embodiment of a process for extracting oil substances from materials bearing the oil substances;

FIG. 3 is a schematic view of an additional embodiment of a process for extracting oil substances from materials bearing the oil substances; and

FIG. 4 is a schematic view of one embodiment of a concentrator useful in accordance with the principles of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present compositions and methods for extracting oil substances from materials such as tar sands and oil shale are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

As used herein, the phrase “oil substances” shall refer generally to any variety of oil or oil bearing substances, including bitumen, tar, hydrocarbons, or petroleum, for example.

As used herein, the phrase “atmospheric conditions” shall be construed to include conditions, such as pressure, in the ambient where the steps of the disclosed process are taking place.

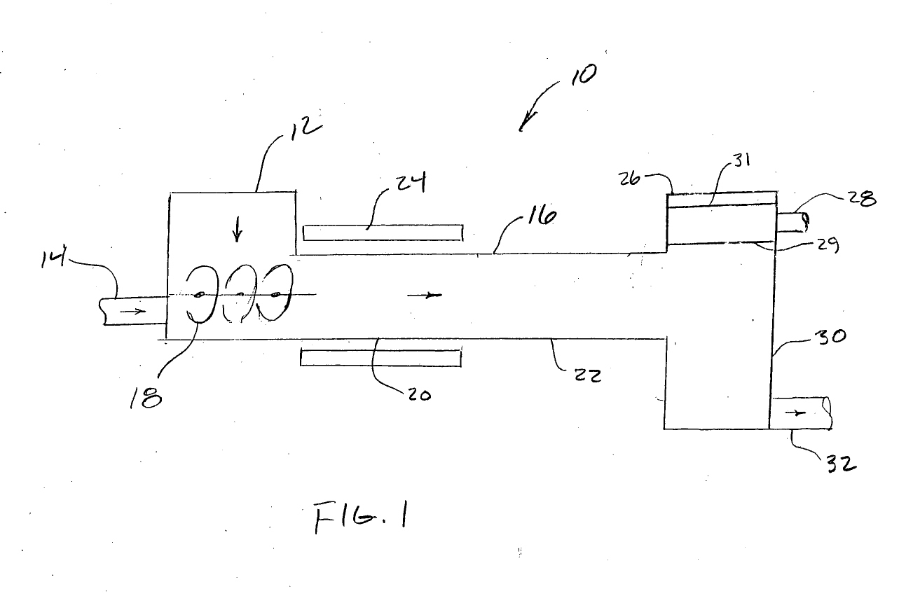

Referring now to FIG. 1, a schematic view is shown of one embodiment of a process, indicated generally at 10, for extracting oil substances from materials bearing such oil substances. It will be understood that the illustration of the process 10 in FIG. 1 is merely schematic in nature and is not intended to be representative of the actual appearance or proportions of the process 10. It will also be understood that the arrows shown in FIG. 1 depict one embodiment of the movement of water and materials in the process 10.

It will be understood that the materials bearing such oil substances may include sand, sometimes referred to as tar sands, oil sands, or bituminous sands or gravel, coal, or shale or any other such variety of material. The materials bearing the oil substances may be mined or otherwise obtained in any manner known in the art.

Oil bearing materials may be placed in an entrance 12 of the process 10, such as a hopper or container having an opening. Water may also be supplied to the process 10 through the entrance 12 or a water conveyance 14. It will be understood that the water conveyance 14 may be provided in the form of a pipe or channel or any other mechanism for transporting water into the process 10. The water may be transported to the process 10 from any suitable source, including water recycled from the process 10.

Any variety of chemical conditioning agents known to those skilled in the art, such as flotation agents or frothing agents, may also be placed in the entrance 12, or other portal in the process 10, for assisting in separating the oil substance from the oil bearing materials. Some of the known conditioning agents may include kerosene, diesel, or methyl-isobutyl-carbinol (MIBC), for example. It will be understood that the oil bearing materials and the water may be mixed together to form a slurry or flowable material. The oil bearing materials and the water may be transported through a chamber or conduit 16 by any manner known in the art, such as a screw or auger mechanism 18, or by pumps, conveyors or gravity, for example. The conduit 16 may be formed in any suitable configuration having any suitable size and length. For example, one embodiment of the present disclosure may include a conduit 16 in the form of a metal pipe having a substantially uniform diameter configured to carry the desired flow of slurry. Other embodiments of the conduit 16 may include different configurations along the length of the conduit 16, and various bends, curves, joints, or valves may be provided in the conduit 16. One embodiment of the conduit 16 may also be rotatable to allow the material in the conduit to tumble to facilitate movement of material in the conduit 16.

The conduit 16 may include a first portion 20 and a second portion 22. The first portion 20 may be heated and the second portion may be cooled with respect to the first portion. A heat source 24 may be applied to the first portion to heat the slurry of water and oil bearing materials. It will be understood that any variety of heating mechanism known in the art may be used, such as combustion of flammable gasses or other materials to produce flame heating, or electrical resistance heating, for example. The heat source 24 may completely surround the conduit 16, or alternatively, the heat source 24 may act on only a portion of a perimeter of the conduit 16.

It will be understood that the slurry may be transported through the first portion 20 of the conduit 16 to thereby heat the slurry. As the slurry of water and oil bearing materials is heated, oil substances in the material may be more readily liberated or released and separated from the material into the water. The mixing action of the slurry as it is transported through the conduit 16 may also facilitate washing the oil substances out of the material. This may be enhanced due to the agitation of the water and oil bearing substances caused by the auger 18. It will be understood that the length of the first portion 20 of the conduit 16 may vary as desired to achieve the desired heating of the slurry, as the longer the first portion 20, the greater the retention time of the slurry in the first portion 20 of the conduit 16. Moreover, the heat applied using the heat source 24 may vary to achieve a desired temperature of the slurry.

One embodiment of the present disclosure may include the conduit 16 configured such that the slurry may be pressurized within the first portion 20 of the conduit 16. The increased pressure in the conduit 16 may be achieved due to the confinement of the conduit 16 itself, or pressure maintaining devices or valves may be used in connection with the conduit 16. Accordingly, when the slurry is heated in the first portion 20 of the conduit 16, temperatures above the boiling point of water at atmospheric conditions may be achieved. Such high temperatures may improve the ability of the process 10 to liberate the oil substances from the oil bearing materials as compared with systems in which boiling water is mixed with the oil bearing materials. Moreover, the efficiency of the process may be improved over lower temperature operations in which volumes of water are heated to boiling for use in washing oil substances out of tar sands and shale.

It will be understood that as the slurry moves to the second portion 22 of the conduit 16, the slurry may be allowed to cool. One embodiment of the present disclosure may provide the second portion 22 of the conduit arranged to be cooled by the ambient surrounding the conduit 16. Other embodiments may include the second portion 22 of the conduit 16 passing through a water jacket or water bath or any other known cooling system to thereby enhance cooling of the slurry. As the slurry passes through the conduit 16, the oil substances will tend to float on the water in the slurry to thereby accumulate in an upper portion of the conduit 16. Moreover, as the materials exit the conduit 16, they have been cooled adequately to reduce vapor emissions. For example, the temperatures of the water exiting the conduit 16 may be cooled to the point where significant amounts of steam may not be emitted. This may be an advantage over some embodiments in which cooling of the materials is accomplished in the atmosphere, since such operations may emit excessive steam and vapors into the environment. In contrast, one embodiment of the present disclosure allows cooling of the water and oil bearing materials in the enclosed second portion 22 of the conduit such that steam and vapor emissions to the environment may be reduced. Accordingly, the length and cooling characteristics of the second portion 22 of the conduit 16 may be configured to allow the desired cooling of the slurry prior to exiting the process 10.

A separator 26 may be provided to separate the oil substance from the slurry. It will be understood that any variety of separation mechanism known in the art may be used to separate the oil substance from the water. For example, one embodiment may include a mechanism for skimming the oil substance off the water. Alternatively, the water may be transported to a holding tank and the level of fluid in the tank may be regulated such that the oil substance spills over the top into a trough, or the oil may be withdrawn through a pipe or channel, whereas the water may be withdrawn at a lower elevation in the tank. It will be understood, however, that any known mechanism for separating oil substances from water may be utilized.

The oil substance may then be transported through an oil conveyance 28 for storage, refinement and/or use. The oil conveyance 28 may be formed in any manner known in the art, such as a pipe or channel for carrying a fluid substance.

The water and remaining solid material may be removed from the conduit 16 through a waste area 30. One embodiment of the waste area may include a container configured to allow solid material to settle to the bottom for removal whereas the fluid may be removed from an upper level of the container. Accordingly, the water may be separated from the solid material. Another embodiment of the waste area 30 may include screens or grates to facilitate separating the solid and fluid materials. Yet another embodiment of the present disclosure may include a waste area in which the waste material may be transported to ponds or piles in which the water is allowed to evaporate or seep from the solid materials. It will be understood that the water and solid materials exiting the conduit 16 may be disposed in any manner known to those skilled in the art, and various different waste or environmental treatment processes may be utilized within the scope of the present disclosure to ensure that the environment is protected. One embodiment of the present disclosure may transport water from the waste area 30 to the water conveyance 14 for recycling the water through the process 10.

In one embodiment of the present disclosure, the waste area 30 may be configured such that water in the waste area 30 may be maintained at a level as indicated at 29. The oil substance may float on the water to an oil level 31. Thus, the oil substance may be maintained at a level for being withdrawn through the oil conveyance 28. It will be understood that in some embodiments, the water level 29 and/or the oil level 31 may be maintained above the conduit 16 such that a higher pressure may be maintained in the conduit 16. Alternatively, other embodiments may include the waste area 30 below the conduit 16 such that the water level 29 and/or the oil level 31 may be even with or below the conduit 16.

It will be understood that one embodiment of present disclosure may include the oil conveyance 28 as a first exit for the conduit 16 and the waste area 30 forming a second exit 32 of the conduit 16. It will also be appreciated that other embodiments of the present disclosure may have different quantities of exits in different arrangements. For example, one embodiment of the present disclosure may have a single exit in which all the contents of the conduit flow into a container, and wherein the oil substance, water, and solid materials may be separated in the container. Other embodiments of the conduit may have more than two exits for releasing different types of materials, such as one for oil substances, one for primarily water, and one for primarily solid materials, for example.

One embodiment of the present disclosure may include a process that may operate continuously rather than in batches such that an efficient operation may occur. Moreover, since conduits are commonly used to carry oil bearing materials, at least a portion of the process 10 may include structures used to transport the oil bearing materials. In other words, processing of the oil bearing materials may take place as the materials are being transported.

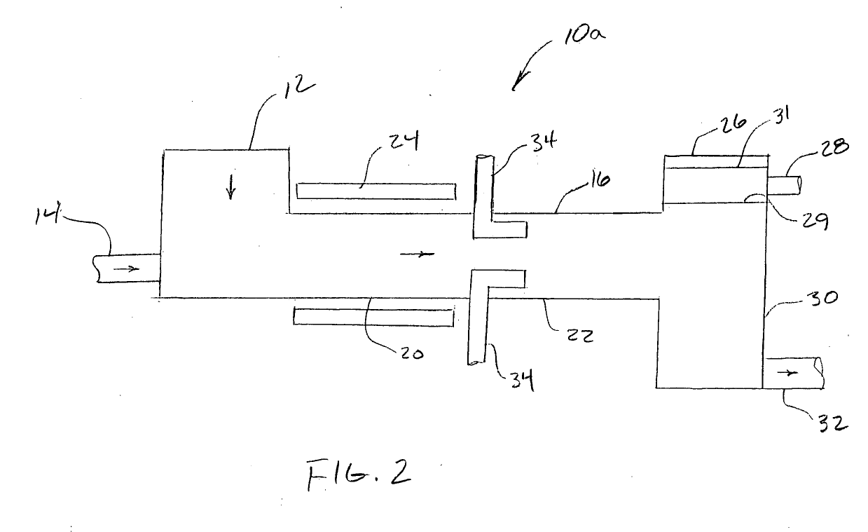

Reference will now to made to FIG. 2 to describe another embodiment of the present disclosure. As previously discussed, the presently disclosed embodiments illustrated herein are merely exemplary of the possible embodiments of the disclosure, including that illustrated in FIG. 2.

It will be appreciated that the embodiment of the disclosure illustrated in FIG. 2 contains many of the same features represented in FIG. 1 and only the new or different features will be explained to most succinctly explain the additional advantages that come with the embodiment of the disclosure illustrated in FIG. 2. The embodiment of the disclosure of FIG. 2 includes a process 10a having injectors 34 for injecting water into the conduit 16. It will be understood that the injectors 34 may transport water from any source similar to the water conveyance 14. The injectors 34 may enhance the agitation of water and oil bearing materials to enhance liberation of oil substances from the materials.

The injectors 34 and the conduit 16 may be arranged in a manner such that a suction or reduced pressure force may be created behind the injectors 34 to facilitate moving the water and oil bearing materials in the conduit 16 behind the injectors 34. Moreover, the flow of water in front of the injectors 34 may also assist in moving the water and material in the conduit 16 in front of the injectors 34. It will be understood that the suction force may be created in a manner similar to that in a venturi, for example, and that any number of injectors 34 may be used to facilitate movement of the water and material in the conduit 16. Moreover, the injectors 34 may be positioned at multiple positions along the length of the conduit 16 in accordance with the principles of the present disclosure. Use of injectors 34 may be beneficial in eliminating mechanical equipment within the conduit 16, thereby facilitating operation and maintenance of the process 10a.

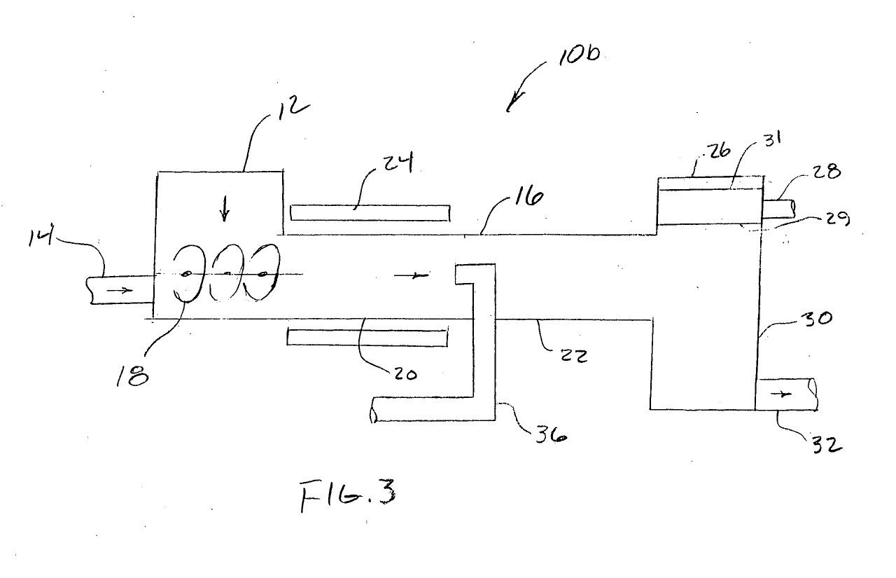

Reference will now to made to FIG. 3 to describe an additional embodiment of the present disclosure. As previously discussed, the presently disclosed embodiments illustrated herein are merely exemplary of the possible embodiments of the disclosure, including that illustrated in FIG. 3.

It will be appreciated that the embodiment of the disclosure illustrated in FIG. 3 contains many of the same features represented in FIGS. 1 and 2, and only the new or different features will be explained to most succinctly explain the additional advantages that come with the embodiment of the disclosure illustrated in FIG. 3. The embodiment of the disclosure of FIG. 3 includes a process 10b that may include one or more water recycle lines 36. The water recycle line 36 may be positioned and configured to draw water from the conduit 16 after the water has been heated and before the water has been cooled significantly in the second portion 22 of the conduit. The water may be recycled through the water conveyance 14 such that it enters into the conduit 16 in a pre-heated condition. It will be understood that the size, location and quantity of the water recycle lines 36 may vary within the scope of the present disclosure.

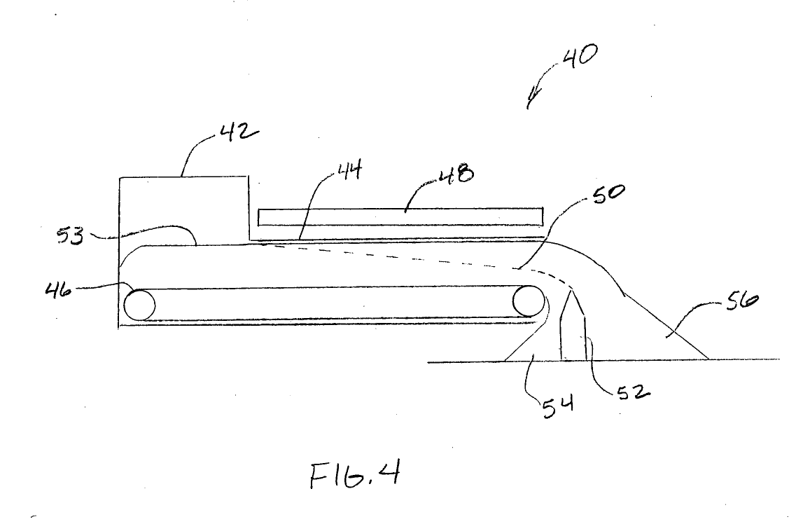

Referring now to FIG. 4, a schematic view of a concentrator is shown, indicated generally at 40. The concentrator 40 may be used alone or in combination with the process 10 to concentrate the quantity of oil substances into a portion of the material bearing the oil substances. It will be understood that when referring to the process 10 with respect to FIG. 4, the processes 10a or 10b, or other such processes shall also be included. It will be appreciated that the material having the oil substances concentrated therein may be fed into the entrance 12 of the process 10 to thereby enhance the efficiency of the process 10, and/or to reduce the quantity of water required to operate the process 10. This may provide advantages in that some of the known methods for extracting oil substances from oil bearing materials may require the use of large quantities of water. Access to such water and/or disposal of the water has been a problem in some of the known oil extraction processes.

The concentrator 40 may include a concentrator entrance 42 for receiving oil bearing materials, similar to the entrance 12 of the process 10. The oil bearing material may transported through the entrance 12 to a concentrator conduit 44 using a conveyance device 46, such as a conveyor or any other suitable mechanism for moving material known to those skilled in the art. It will be understood that the concentrator conduit 44 may be enclosed or open, and the concentrator conduit 44 may be configured an any suitable arrangement known to those skilled in the art. A concentrator heat source 48 of a type and configuration similar to the heat source 24 used in the process 10 may also be provided.

It will be understood that as material bearing the oil substances, indicated at 53, travels through the conduit 44, oil substances in the material may accumulate in the bottom portion of the material. This may be accomplished due to the heat applied by the heat source 48 heating the material 53 and causing the oil substances to become more fluid, allowing the substances to flow and accumulate in the bottom of the material 53. Concentrating of the oil substances may also be accomplished as the volatile substances in the material 53 may be vaporized. The vapors may condense in the lower part of the material 53 since the temperature of the material 53 may be lower near the bottom of the material 53 away from the heat source 48. In such situations, a heat wedge, indicated by dashed lines at 50, may be formed such that the further the material 53 moves along the heat source 48, the deeper the higher temperatures from the heat source 48 reach into the material 53. For example, as the material 53 is initially exposed to the heat from the heat source 48, only the upper portion of the material 53 may be heated whereas the lower portion of the material 53 may remain at a lower temperature. However, as the material 53 travels in the conduit 44 and becomes exposed to heat longer, the temperature of the material 53 in the lower portions of the conduit 44 also become heated. It will be understood that the length of the heat source 48 or the time of exposure to the heat source 48 may be adjusted to achieve a desired configuration of a heat wedge 50 in the material 53, or to achieve the desired concentration of oil substances.

It will be understood that as the volatile substances condense in the lower portion of the material 53, or the oil substances flow to the lower portion of the material 53, the concentration of oil substances in the lower portion of the material may increase, whereas the concentration of the oil substances in the upper portion of the material may decrease. A separator 52 may be used at an end portion of the conduit 44 to separate material with concentrated oil substances, indicated at 54, from the remainder of the material, indicated at 56. Any variety of separator mechanism for separating portions of material from the output of a system, known to those skilled in the art, may be used. For example, one embodiment of the separator 52 may include a divider arranged to be positioned such that material on a lower portion of the conduit 44 accumulates at one location, whereas material in an upper portion of the conduit 44 accumulates at another location. The position of the separator 52 may be adjusted to separate the material 53 in a desired manner.

The material with the concentrated oil substances 54 may then be fed into the entrance 12 of the process 10 such that the volume of material processed in the process 10 may be reduced as compared to situations in which unconcentrated materials are fed into the process 10. Since a reduced quantity of material may be fed into the process 10, the amount of water used in the process 10 may also be reduced for a given quantity of oil substances produced. The remainder of the material 56 may be used, treated or disposed in any suitable manner known to those skilled in the art. Accordingly, it will be understood that the concentrator 40 may be used in combination with the process 10 to enhance efficiency of the process 10 or reduce the amount of water consumed in the process 10. It will be understood, however, that the concentrator 40 may also be used in other suitable applications known to those skilled in the art.

It will be understood that the structural components of the present disclosure may be formed in a manner known in the art using known materials suitable for their intended purposes.

In accordance with the features and combinations described above, a useful method for extracting an oil substance from an oil bearing material may include:

placing the material and water in a conduit;

heating the water to a temperature above the boiling point of water at atmospheric conditions;

liberating the oil substance from the material with the water; and

separating the oil substance from the water.

Those having ordinary skill in the relevant art will appreciate the advantages provide by the features of the present disclosure. For example, it is a feature of the present disclosure to provide a process for extracting oil substances from oil bearing materials that is simple in design, manufacture and operation. Another feature of the present disclosure is to provide such a process that is efficient in energy use. It is a further feature of the present disclosure, in accordance with one aspect thereof, to provide a process for removing oil substances from oil bearing materials that reduces the emissions of volatile substances into the environment. It is a further feature of the present disclosure to provide a process for removing oil substances from oil bearing materials that allows water to be pressurized and heated above the boiling point of water at atmospheric conditions to thereby enhance its ability to liberate the oil substances from the material. It is another feature of the present disclosure to provide a process for removing oil substances from oil bearing materials that allows processing water to be recycled.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function, and manner of operation, assembly, and use may be made without departing from the principles and concepts set forth herein.

What is claimed is:

1. A method for extracting an oil substance from an oil bearing material, said method comprising:
placing said material and water in a conduit;
heating a first portion of said conduit to facilitate liberating said oil substance from said material with said water;
cooling said material and water in a second portion of said conduit;
allowing said oil substance to float on said water; and
separating said oil substance from said water.

2. The method of claim 1, further comprising heating said water to a temperature above the boiling point of water at atmospheric conditions.

3. The method of claim 1, further comprising mixing said material and said water.

4. The method of claim 1, further comprising pressurizing said first portion of said conduit above atmospheric pressure.

5. The method of claim 1, further comprising transporting said oil substance out a first exit of said conduit.

6. The method of claim 1, further comprising transporting said water and said material out a second exit of said conduit.

7. The method of claim 1, further comprising recycling said water through said conduit.

8. The method of claim 1, further comprising moving said water and said material in said conduit using pressurized water through injectors.

9. The method of claim 1, further comprising removing heated water from said conduit and recycling said heated water in said conduit.

10. The method of claim 1, further comprising placing a conditioning agent in said conduit.

11. A method for extracting an oil substance from an oil bearing material, said method comprising:
placing said material and water in a conduit;
heating said water to a temperature above the boiling point of water at atmospheric conditions;
liberating said oil substance from said material with said water; and
separating said oil substance from said water.

12. The method of claim 11, further comprising mixing said material and said water.

13. The method of claim 11, further comprising cooling said material, said water, and said oil substance in said conduit.

14. The method of claim 11, further comprising pressurizing a portion of said conduit above atmospheric pressure.

15. The method of claim 11, further comprising transporting said oil substance out a first exit of said conduit.

16. The method of claim 11, further comprising transporting said water and said material out a second exit of said conduit.

17. The method of claim 11, further comprising recycling said water through said conduit.

18. The method of claim 11, further comprising moving said water and said material in said conduit using pressurized water through injectors.

19. The method of claim 11, further comprising removing heated water from said conduit and recycling said heated water in said conduit.

20. A method for extracting an oil substance from an oil bearing material, said method comprising:
placing said material and water in a conduit;
pressurizing a first portion of said conduit above atmospheric pressure;
liberating said oil substance from said material with said water; and
separating said oil substance from said water.

21. The method of claim 20, further comprising heating said water to a temperature above the boiling point of water at atmospheric conditions.

22. The method of claim 20, further comprising mixing said material and said water.

23. The method of claim 20, further comprising allowing said oil substance to float on said water.

24. The method of claim 20, further comprising transporting said oil substance out a first exit of said conduit.

25. The method of claim 24, further comprising transporting said water and said material out a second exit of said conduit.

26. A method for extracting an oil substance from an oil bearing material, said method comprising:
providing a conduit having a first portion and a second portion;
heating said first portion of said conduit with respect to said second portion;
placing said material in said conduit;
transporting said material from said first portion of said conduit to said second portion of said conduit;
liberating said oil substance from said material; and
directing said oil substance out a first exit of said conduit and directing a remainder of the material in the conduit out a second exit of the conduit.

27. The method of claim 26, further comprising placing water in said conduit.

28. The method of claim 27, further comprising mixing said material and said water.

29. The method of claim 28, further comprising allowing said oil substance to float on said water.

30. The method of claim 27, further comprising heating said water to a temperature above the boiling point of water at atmospheric conditions.

31. The method of claim 26, further comprising pressurizing said first portion of said conduit above atmospheric pressure.

32. A method for extracting an oil substance from an oil bearing material, said method comprising:
mixing said material with water to form a slurry;
transporting said slurry through a conduit;
allowing said oil substance to float on said water; and
directing said oil substance out a first exit of said conduit and directing a remainder of the materials in the conduit out a second exit of the conduit.

33. The method of claim 32, further comprising heating a first portion of said conduit.

34. The method of claim 33, further comprising heating said water to a temperature above the boiling point of water at atmospheric conditions.

35. The method of claim 33, further comprising cooling said slurry in a second portion of said conduit.

36. The method of claim 32, further comprising pressurizing a first portion of said conduit above atmospheric pressure.

37. The method of claim 32, further comprising recycling said water through said conduit.

38. The method of claim 32, wherein mixing said material with water comprises moving said material with an auger in said conduit.

39. The method of claim 32, further comprising heating a first portion of said conduit;
heating said water to a temperature above the boiling point of water at atmospheric conditions;
cooling said slurry in a second portion of said conduit to reduce emission of vapors from said conduit;
pressurizing said first portion of said conduit above atmospheric pressure;
recycling said water through said conduit;
wherein mixing said material with water comprises moving said material with an auger in said conduit; and
wherein heating said water comprises combusting flammable materials to create a flame for heating said conduit.

40. The method of claim 32, further comprising treating said oil bearing material before mixing said material with water to concentrate said oil substances in a portion of said material.

41. The method of claim 40, wherein treating said oil bearing material comprises heating said oil bearing material to cause said oil substances to concentrate in said portion of said oil bearing material.

42. The method of claim 41, further comprising separating said portion of said material concentrated with said oil substances from a remainder of said material.
